(19) United States
(12) Patent Application Publication
(10) Pub. No.: US 2011/0125568 A1
(43) Pub. Date: May 26, 2011

(54) Shared-Benefit Reward System and Method

(75) Inventor: Troy John Manhire, Adelaide (AU)

(73) Assignee: Ezygive Pty Limited, Adelaide (AU)

(21) Appl. No.: 12/949,779

(22) Filed: Nov. 19, 2010

(30) Foreign Application Priority Data
Nov. 20, 2009 (AU) 2009905680

(51) Int. Cl. G06Q 30/00

(52) U.S. Cl. 705/14.34

(57) ABSTRACT

A method and apparatus for allocating a portion of a purchase-based member reward to a third party beneficiary thereby to enable a shared benefit membership reward in a computer system. The method comprise the steps of receiving a member card at a merchant point of sale, identifying data indicative of a member and a third party beneficiary associated with the member card, calculating a defined benefit in respect of a purchase value, apportioning a percentage of the defined benefit to the member, and apportioning a remaining portion of the defined benefit contributed toward the third party beneficiary.

### FIELD OF THE INVENTION

The present invention relates to membership reward systems and methods, and in particular to a shared benefit membership reward system and method.

The invention has been developed primarily for use as a shared benefit membership reward system and method and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known membership reward systems and methods include issuing a membership reward card to a member, whereby a merchant keep track of any accumulated member reward. In its simplest configuration, a card identifies a member using bar codes or magnetic strip. The reward offered to the card member typically accrues directly to a member account.

It is further known that a third party membership card provider can issue a member with a reward card that is accepted at a plurality of merchants, whereby a card provider keeps track of any accumulated reward in a member account. In some instances, the reward card may be associated with a credit card or payment functionality, for enabling payment of purchases made at the merchant store and to simultaneously identify and/or record any associated reward.

It will be understood that a client typically redeem accumulated rewards from, or though, the card provider. However, it would be understood that these methods of providing membership rewards only directly benefit a single member.

### OBJECT OF THE INVENTION

It is an object of the present invention to overcome or ameliorate at least one of the disadvantages of the prior art, or to provide a useful alternative.

It is an object of the invention in its preferred form to provide a shared benefit membership reward system and method.

### SUMMARY OF THE INVENTION

According to a first aspect of the invention there is provided a shared benefit membership reward apparatus for allocating a portion of a purchase-based member reward to a third party beneficiary, the apparatus comprising:
a processor adapted to interrogate a member card for identifying data indicative of a member and/or third party beneficiary;
the processor being further adapted to calculate a defined benefit in respect for a purchase value, apportion a percentage of the defined benefit to the member and apportion a remaining portion of the defined benefit toward a transfer of funds to the third party beneficiary.

Preferably, the processor is available at a merchant point of sale. More preferably, the processor is couplable to a data network, and is further adapted to transmit data across the data network to a payment processing provider for enabling a funds transfer from a merchant account to a third party beneficiary account. Most preferably, enabling the funds transfer from a merchant account to a third party beneficiary account initially requires transferring funds to an intermediary account.

According to a second aspect of the invention there is provided a method of allocating a portion of a purchase-based member reward to a third party beneficiary thereby to enable a shared benefit membership reward in a computer system, the method comprising the steps of:
a) providing (or receiving) a member card at a merchant point of sale;
b) identifying data indicative of a member and/or a third party beneficiary associated with the member card;
c) calculating a defined benefit in respect for a purchase value; and
d) apportioning a percentage of the defined benefit to the member and apportioning a remaining portion of the defined benefit being contributed toward the third party beneficiary.

Preferably, a defined benefit is calculated in respect of a member card indicated associated member and/or third party beneficiary. More preferably, a member can specify a smaller percentage apportioned to the member—and therefore a larger percentage apportioned to the third party beneficiary. Most preferably, data indicative of the defined benefit and percentage apportioned to the member is retained by the member card. Alternatively, data indicative of the defined benefit and percentage apportioned to the member is retained in a database record associatable with the member card.

Preferably, data indicative of a member and a third party beneficiary associated with the member card is retained by the member card. Alternatively, data indicative of a member and a third party beneficiary associated with the member card can be retained in a database record associatable with the member card.

Preferably, a merchant has a pre-defined benefit in respect for a purchase value. More preferably, the benefit is applied as a monetary benefit. Most preferably, the benefit is shared between at least the member and the third party beneficiary.

Preferably, a merchant has a defined monetary benefit in respect for a purchase value. More preferably, the defined monetary benefit is applied, whereby a percentage of the defined benefit is a rebate to the member purchase and a remaining portion of the defined benefit contributes toward a transfer of funds to a third party beneficiary. Fees and charges are preferably extracted from the remaining portion of the defined benefit. The percentage of the defined benefit is preferably predetermined.

Preferably, a remaining portion of a defined benefit contributes toward a transfer of funds to a third party beneficiary. The remaining portion of a defined benefit is preferably temporarily held in a trustee account. More preferably, fees and charges are deducted from a held remaining portion of a defined benefit. Most preferably, a transfer of funds is made to the third party beneficiary for a cash value of the remaining portion of a defined benefit less the fees and charges.

According to a further aspect of the invention there is provided a processor apparatus for allocating a portion of a purchase-based member reward to a third party beneficiary thereby to enable shared-benefit membership reward, the apparatus comprising:
a processor adapted to interrogate a member card to identify data indicative of a member and third party beneficiary;
the processor being further adapted to calculate a defined benefit in respect for a purchase value, apportion a percentage of the defined benefit to the member and a remaining portion of the defined benefit toward a transfer of funds to the third party beneficiary.

According to a further aspect of the invention there is provided an access interface for a processor device, the processor device being adapted to allocate a portion of a purchase-based member reward to a third party beneficiary thereby to enable shared benefit membership reward, the processor device being coupleable to a data network; the interface comprising: a control program adapted to perform a method as herein described.

According to a further aspect of the invention there is provided a computer program product stored on a computer usable medium, the computer program product adapted to provide a method of allocating a portion of a purchase-based member reward to a third party beneficiary, thereby to enable shared benefit membership reward, as herein described.

According to a further aspect of the invention there is provided a computer readable medium for operation with a processor device to enable a shared benefit membership reward apparatus, the computer readable medium comprising computer code for executing a method of allocating a portion of a purchase-based member reward to a third party beneficiary as herein described.

### BRIEF DESCRIPTION OF THE DRAWINGS

A preferred embodiment of the invention will now be described, by way of example only, with reference to the accompanying drawings in which:

FIG. 1 is an example schematic view of a shared benefit membership reward apparatus according to the invention;

FIG. 2 is an example schematic view of the apparatus of FIG. 1, further showing card provider server and a member provider server;

FIG. 3 is an example flowchart for a method of allocating a portion of a purchase-based member reward to a third party beneficiary according to the invention;

FIG. 4 is an example flowchart for a method of FIG. 3, showing steps associated with apportioning a remaining portion of a defined benefit to the third party beneficiary; and

FIG. 5 is an alternative example flowchart for a method of allocating a portion of a purchase-based member reward to a third party beneficiary according to the invention.

### PREFERRED EMBODIMENT OF THE INVENTION

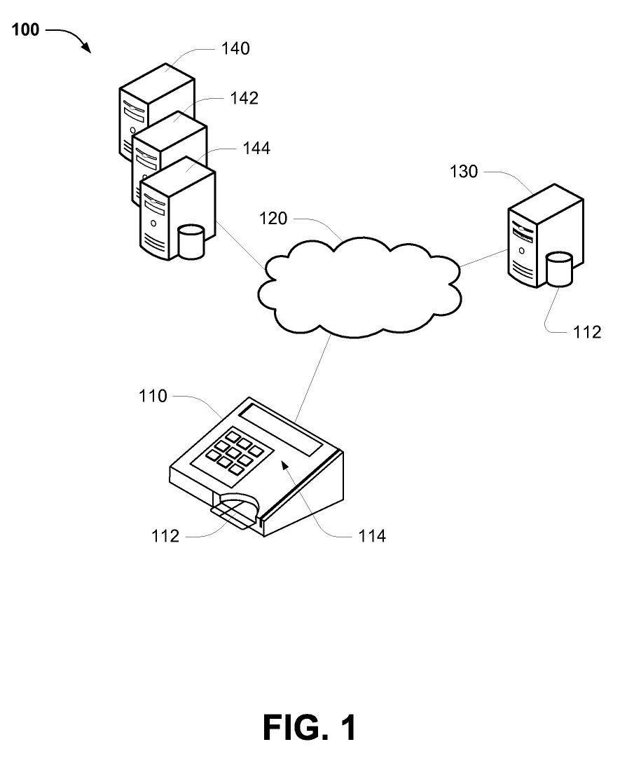

Referring initially to FIG. 1 of the drawings, a shared benefit membership reward apparatus 100 is shown for allocating a portion of a purchase-based member reward to a third party beneficiary. The apparatus comprises a processor device 110 adapted to interrogate a member card 112 to identify data indicative of a member and third party beneficiary. The processor is further adapted to calculate a defined benefit in respect for a purchase value, apportion a percentage of the defined benefit to the member and a remaining portion of the defined benefit toward a transfer of funds to the third party beneficiary.

The processor device 110 is coupled to a data network 120, and is further adapted to transmit data across the data network to a payment processing provider 130. The payment processing provider enables a funds transfer from a merchant account held by one account server 140 to an intermediary account 142. Fees and charges are typically extracted from the intermediary account, and remaining funds are transferred to a third party beneficiary account 144.

It will be appreciated that the processor device 110 is typically available at a merchant point of sale. A merchant has a defined benefit in respect for a purchase sale value. The defined benefit is applied as a monetary benefit, which can be shared between at least the member and a third party beneficiary. A percentage (for example 50%) of the defined benefit can be applied as a rebate to the member purchase sale price and a remaining portion of the defined benefit can be contributed toward a transfer of funds to the third party beneficiary. Fees and charges associated with the funds transfer, and maintenance of the apparatus, can be extracted from the remaining portion of the defined benefit.

The processor device 110 enables merchants to provide discounts on portions of a purchase made by a member having a membership reward (or loyalty, or discount) card. A member can carry a single card to both receive a discount at a plurality of merchant locations and to direct funds to a third party beneficiary. Further, a consolidated membership/reward card and credit card may also be provided.

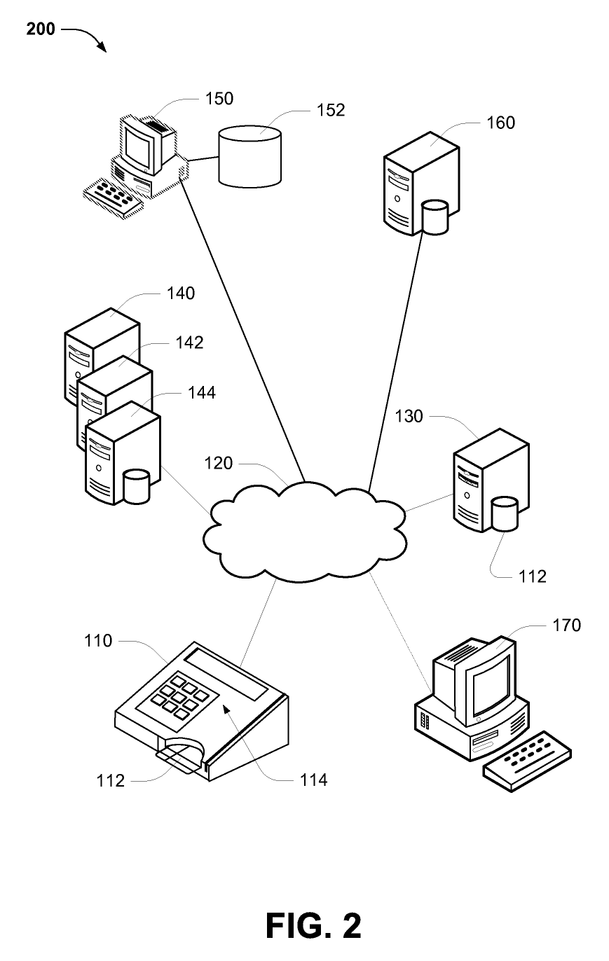

FIG. 2 shows an example schematic view of an apparatus 200 that further comprises a card provider server 150 and a member provider server 160. The card provider server 150 is coupled to a database 152 for maintaining data indicative of members and their assigned member cards.

In an embodiment, a card provider manages the production of the cards, and their acceptance at one or more merchants. Members may be invited or introduced from a partner or a third party beneficiary. This partner (or third party beneficiary) can include a public or private company corporation, public service provider (utility, telecom), charity or non-profit group, etc. Preferably, the partner (or third party beneficiary) has a customer/client database that can be used to introduce new members for receiving a card.

By way of example only, the card provider may also be authorised to issue cards to a member who makes direct contact with the card provider. In this example, a third party beneficiary can be selected by the new member, or assigned by the card provider.

The merchant is typically contractually obliged to rebate a specific percentage of every purchase amount spent by a member. This rebate can be offered as an immediate discount to the purchase amount and/or a monetary transfer to a third party beneficiary (possibly via an intermediary trustee account). Any monetary value transferred to the third party beneficiary can be managed by, and is the property of, the beneficiary.

It will be appreciated that both the defined benefit and the percentage of the defined benefit applied to the member and the third party is typically predetermined by the card provider, or at the issuance of the card to the member. In this example, a defined benefit is calculated in respect of a member card indicated associated member and/or third party beneficiary.

In an embodiment, by way of example only, a member can specify a smaller percentage apportioned to the member—and therefore a larger percentage apportioned to the third party beneficiary. Data indicative of the defined benefit and percentage apportioned to the member is retained by the member card 112, or a database record 152 associated with the member card.

It will be apprenticed that data indicative of a member and a third party beneficiary associated with the member card can be retained by the member card. Alternatively, data indicative of a member and a third party beneficiary associated with the member card can be retained in a database record 152 associated with the member card.

In these examples, a card provider is typically a company that has been set up to market the business idea of associated with the reward card. A card provider liaise with one or more retailers and/or service providers to formulate agreements associated with the providing of benefits to members. This can include the quantum of the benefit, the proportioning of any benefit, and the means of applying the benefit. A card member typically obtains financial benefits upon production of the card at the time of purchase of a service or product.

Responsibilities of a card provider can include any one or more of the following:
signing agreements with merchants to provide benefits to members;
encouraging third party beneficiaries (of example charities) to join and provide cards to their clients;
providing logos and card designs; and
transferring allocated funds to third party beneficiary bank accounts and collecting and/or paying associated administration/management fees and charges.

It will be appreciated that a card provider can:
enable raising of funds for a third party beneficiary, such as charities and good causes; and
enable a return of profits to the card provider, and its shareholders.

In an embodiment, the card provider can provide reward cards to one or more charities who have registered to participate.

In an embodiment, a card provider may have a trust account (bank account) that receives a remaining portion of a benefit transferred prior to being transferred to a third party beneficiary. This can enable the withdrawal and/or collection of associated administration (or transaction) fees and charges.

These administration fees and charges are typically collected prior to a benefit being sent to a third party beneficiary, and can include any one or more of: management charges imposed by a payment processing provider; management charges imposed by a card provider; electronic funds transfer fees; and/or other maintenance and support fees.

It will be appreciated that Electronic Funds Transfer at Point of Sale (EFTPOS) is a financial network for processing credit cards, debit cards and charge card payments at “Point of Sale”. EFTPOS also enables users of the system to withdraw cash or have money refunded to their account in the event of a returned item or cancelled service through a merchant EFTPOS terminal.

In an embodiment, a payment processing provider is typically a company that produces a payment processing operating system that enables a reward card to enable a transfer of financial benefits from a merchant to a third party beneficiary. A payment processing provider can also liaise with a card manufacturer for the provision of card security, logos and design, while being responsible for all back-end support. This back-end support can include any one or more of the provision of secure online reporting, call centre support, fraud prevention and payment processing.

Responsibilities of a payment processing provider can include any one or more of the following:
providing a card manufacturer with appropriate card data;
transferring a remaining portion of a benefit funds from a merchant bank to a card provider account;
transferring allocated funds to third party beneficiary bank accounts and collecting and/or paying associated administration/management fees and charges;
maintaining a web interface for providing reporting details to any one or more of card provider, third party beneficiary, member and merchant; and
distributing the pre-registered reward cards to a card provider for subsequent delivery.

In an embodiment, a card manufacturer can provide/manufacture appropriate cards. The cards may be pre-printed with magnetic strips, have numbered identification, and/or personalised. By way of example only, the card manufacturer can print and distribute the cards. The card manufacturer may further print and distribute carrier letters.

In an embodiment, a merchant (for example a retailer or service provider) can agree to provide a financial benefit to card members—on production of the card following their purchase of a service or product. This agreement may be set for a period of time.

By way of example, a merchant can agree to provide a discount on goods or services purchased on production of a reward card. The card member can receive a portion of this benefit (for example 50%) as a reduction in their bill, while the remaining portion of the benefit (for example 50%) can be transferred from a merchant bank account to a third party beneficiary using a payment facility (for example using EFTPOS). This remaining portion of the benefit can be a donation to a third party beneficiary charity. It will be appreciated that a member can pay the total amount less any applied benefit in the normal manner, for example by cash or direct debit or credit.

In an embodiment, a merchant can swipe the reward card through a payment terminal (for example EFTPOS) and enter the donation amount (being the remaining portion of the agreed benefit)—as they would for a refund. This can automatically generates a transfer from the merchant bank account to the nominated bank account. Details of this transaction can be recorded and made available to the merchant to view online.

Each transaction can be identified by the associated reward card number and the merchant acquiring number, which allows the card provider to debit an intermediate trust account and credit the appropriate third party beneficiary with the benefit sum less an agreed administration fee. The administration fee can also be transferred elsewhere, for example to the card provider bank account.

In appropriate jurisdictions, a merchant may be entitled to a tax deduction certificate for the amount donated to a third party beneficiary charity.

In an embodiment, a third party beneficiary, including charities and not-for-profit organisations, can raise funds by enrolling members. Members that use the reward card can raise funds in support of the beneficiary. A third party beneficiary can market the reward card to its client base and encourage take-up. Each participating third party beneficiary can market the card to their supporter base. A participating third party beneficiary may also provide appropriate design and logos for inclusion on the card.

In an embodiment, a member provider may include non-beneficiaries that support a third party beneficiary, whilst at the same time providing their constituent base the benefit of the reward card. For example, a company wishing to support a third party beneficiary can offer the reward card to their staff, whereby staff members use their card to obtain benefits and at the same time raise funds for the third party beneficiary supported by the company.

Members are typically an individual that support the third party beneficiary, by using a corresponding card. It will be appreciated that a portion of the benefits arising from using the card can be transferred to a third party beneficiary. Individual card members may give their entire benefit to the card, rather than accepting a proportion of the benefit for themselves.

In an embodiment, and in the event of an isolated incident (for example a national emergency or natural disaster) a member can have the ability to temporarily redirect benefits to a specific appeal. Alternatively, a card provider and/or a third party beneficiary may be temporarily redirect benefits to a specific appeal. It will be appreciated that this may be further subject to an agreement between the third party beneficiary and member to whom the card is aligned. Once the temporarily period is completed, the association for transferring benefits will be re-established.

A reward card 112 is typically a credit card sized plastic card allowing members to obtain associated benefits, while raise funds for a third party beneficiary. The reward card is can be a non-payment card that is used in conjunction with the payment of bills or purchases. Alternatively, the reward card can be integrated into a payment card, whereby the benefit may be automatically applied at the point of sale.

By way of example, a reward card can have a magnetic strip containing data indicative of a third party beneficiary (for example a charity), a card identification and/or a member identification. The card can further include any one or more of: a unique design of from a third party beneficiary; a card number; a third party beneficiary logo; and a card provider logo.

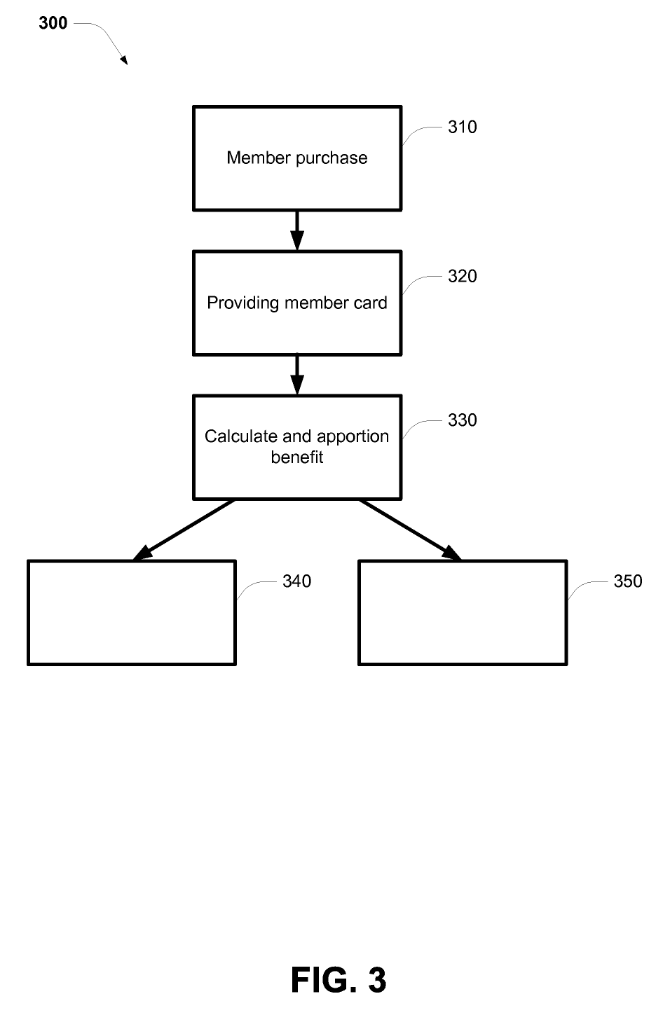

FIG. 3 shows an example flowchart for a method 300 of allocating a portion of a purchase-based member reward to a third party beneficiary, thereby to enable a shared benefit membership reward in a computer system.

In this embodiment, the method 300 is performed at a point of sale and at the time of purchasing goods or services as indicated by STEP 310. The method comprises the steps of:
STEP 320: providing a member card at a merchant point of sale, and identifying, data indicative of a member and a third party beneficiary associated with the member card;
STEP 330: calculating a defined benefit in respect for a purchase value and apportioning a percentage of the defined benefit to the member and apportioning a remaining portion of the defined benefit contributed toward the third party beneficiary.
STEP 340: providing the apportioned percentage of the defined benefit to the member;
STEP 350: providing the remaining portion of the defined benefit to the third party beneficiary.

In an embodiment, providing the remaining portion of the defined benefit to the third party beneficiary can comprise transmitting data across a data network to a payment processing provider for enabling a funds transfer from a merchant account to a third party beneficiary account.

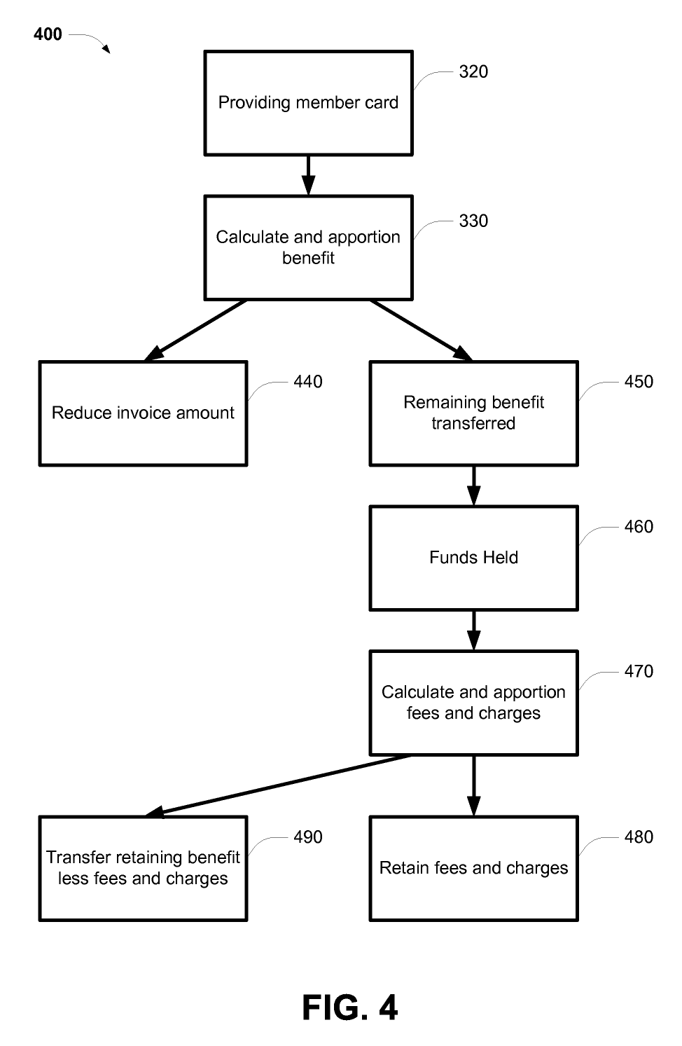

FIG. 4 shows an example flowchart for a method 400 of allocating a portion of a purchase-based member reward to a third party beneficiary, thereby to enable a shared benefit membership reward in a computer system.

In this embodiment, the method 400 comprises the steps STEP 310, STEP 320, and STEP 330 as previously described. By way of example, merchant has a defined monetary benefit in respect for a purchase value. This method further comprises the steps of:
STEP 440: providing the apportioned percentage of the defined benefit to the member as an immediate rebate to the member purchase price;
STEP 450: providing the remaining portion of the defined benefit to contribute toward a transfer of funds to a third party beneficiary, typically requiring transmitting data across the data network to a payment processing provider;
STEP 460: enabling a funds transfer from a merchant account to an intermediary account;
STEP 470: calculating fees and charges associated with funds transfer and maintenance;
STEP 480: extracting, or retaining, from the remaining portion of the defined benefit any calculated fees and charges; and
STEP 490: transferring funds to the third party beneficiary for a cash value of the remaining portion of a defined benefit less any fees and charges.

In an embodiment, by way of example only, a defined benefit can be calculated in respect of a member and/or third party beneficiary associated with a member card. Data indicative of the defined benefit and percentage apportioned to the member can be retained by the member card. Alternatively, data indicative of the defined benefit and percentage apportioned to the member is retained in a database record associated with the member card. A member may specify a smaller percentage apportioned to the member—and therefore a larger percentage apportioned to the third party beneficiary.

In an embodiment: STEP 470 calculates fees and charges associated with funds transfer and maintenance; STEP 480 extracts, or retaining, from the remaining portion of the defined benefit any calculated fees and charges; and STEP 490 transfers funds to the third party beneficiary for a cash value of the remaining portion of a defined benefit less any fees and charges.

In an alternative embodiment, no fees or charges may be levied or extracted at STEP 470 and STEP 480, whereby STEP 490 transfers funds to the third party beneficiary for a cash value of the entire remaining portion of a defined benefit. In this embodiment, fees and charges may optionally be directly levied (for example to a member and/or an affiliate), including any one or more of the following:
a joining fee;
an ongoing fees; and
a periodic fee.

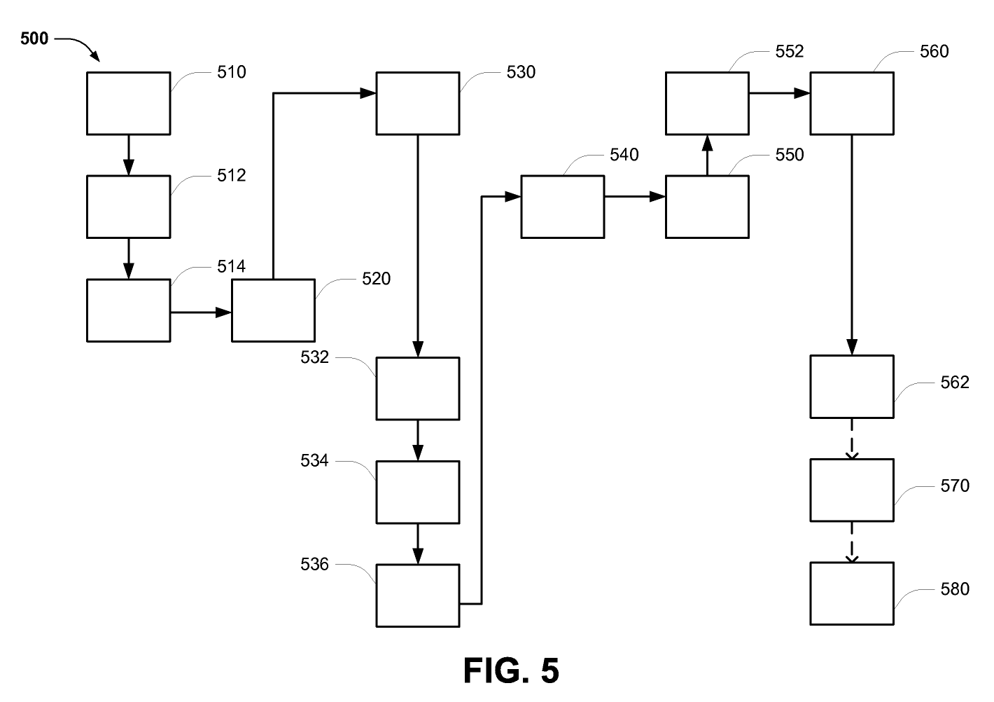

FIG. 5 shows an example flowchart for a method 500 of allocating a portion of a purchase-based member reward to a third party beneficiary. In this embodiment, the method includes the steps of:
STEP 510, a card provider ordering one or more cards from a payment processing provider; including providing designs, logos and member and/or third party data;
STEP 512, the payment processing provider creating card data; and sending/transmitting this data to a card manufacturer;
STEP 514, card manufacturer manufacturing/printing the cards; providing identifying details on the card (for example, a card number, associated third party beneficiary, member details etc) as printed, embossed or stored data;
STEP 520, card manufacturer providing cards, as ordered, to card provider—possibly retaining stock for future orders;
STEP 530, card provider distributing cards (for example to third party beneficiaries);
STEP 532, distributing cards to members (for example by third party beneficiaries to their clients/members);
STEP 534, using, by members, the card at a point of sale of a participating merchant;
STEP 536, the merchant providing an agreed benefit on production of card (for example, 50% of benefit to the member as reduction in the purchase price and the remaining 50% benefit to the third party beneficiary—the member card can be swiped through an EFTPOS terminal as a refund and the remaining 50% benefit);
STEP 540, the payment processing provider receiving data indicative of the transaction from the merchant (or the merchant's bank account server);
STEP 550, the payment processing provider transferring funds from the merchant bank account (possibly delayed to overnight) to the card provider trust account;
STEP 552, card provider accessing a funds transfer report through a web interface provided the payment processing provider for determining balance of funds transferred;
STEP 560, card provider transferring funds (less administration fees and charges) to the respective third party beneficiary bank account; and
STEP 562, the third party beneficiary receiving funds.

It will be appreciated that, in an embodiment, at STEP 562 the third party beneficiary can access transfer reports through web interface provided by the payment processing provider. Further, at STEP 570, a member can access transfer reports through web interface provided by the payment processing provider for checking transfer amounts and other relevant details. Similarly, at STEP 580, a merchant can access transfer reports through web interface provided by the payment processing provider for checking transfer amounts and other relevant details. In relevant jurisdictions, a merchant can further receive a tax invoice (or tax deduction certificate) for confirming a total value of donations made. A web interface can be accessed via a computing system 170 (as best shown in FIG. 2).

In an embodiment, by way of example, there is disclosed a processor apparatus 110 for allocating a portion of a purchase-based member reward to a third party beneficiary thereby to enable a shared benefit membership reward (as best shown in FIG. 1). This apparatus comprises:
a processor adapted to interrogate a member card to identify data indicative of a member and third party beneficiary;
the processor being further adapted to calculate a defined benefit in respect for a purchase value, apportion a percentage of the defined benefit to the member and a remaining portion of the defined benefit toward a transfer of funds to the third party beneficiary.

In an embodiment, by way of example only, there is similarly disclosed an access interface 114 for a processor device 110. The processor device being adapted to allocate a portion of a purchase-based member reward to a third party beneficiary thereby to enable a shared benefit membership reward, the processor device being coupled to a data network 120. The interface comprising: a control program adapted to perform a method as herein described.

In an embodiment, by way of example, there is similarly disclosed a computer program product stored on a computer usable medium, the computer program product adapted to provide a method of allocating a portion of a purchase-based member reward to a third party beneficiary, thereby to enable shared benefit membership reward system, as herein described.

In an embodiment, by way of example, there is similarly disclosed a computer readable medium for operation with a processor device to enable shared benefit membership reward, the computer readable medium comprising computer code for executing a method of allocating a portion of a purchase-based member reward to a third party beneficiary as herein described.

It will be appreciated that the illustrated system and method provide a shared benefit membership reward.

It would be further appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

What is claimed is:

1. A method of allocating a portion of a purchase-based member reward to a third party beneficiary, thereby to enable a shared benefit membership reward in a computer system, the method comprising the steps of:
a) receiving a member card at a merchant point of sale;
b) identifying data indicative of a member;
c) identifying a third party beneficiary associated with the member card;
d) calculating a defined benefit in respect of a purchase value; and
e) apportioning a percentage of the defined benefit to the member and apportioning a remaining portion of the defined benefit being contributed toward the third party beneficiary.

2. The method according to claim 1, wherein the merchant has a pre-defined monetary benefit in respect of a purchase value, and pre-defined monetary benefit can be shared between at least the member and the third party beneficiary.

3. The method according to claim 2, wherein a percentage of the defined benefit is a rebate to a member purchase, and a remaining portion of the defined benefit contributes toward a transfer of funds to the third party beneficiary.

4. The method according to claim 3, wherein fees and charges are extracted from the remaining portion of the defined benefit.

5. The method according to claim 1, wherein a defined benefit is calculated in respect of a member card indicative of the member and the third party beneficiary.

6. The method according to claim 1, wherein data indicative of the member or the third party beneficiary is associated with the member card.

7. The method according to claim 1, wherein data indicative of the defined benefit and percentage apportioned to the member is associated with the member card.

8. The method according to claim 7, wherein a member can specify a smaller percentage apportioned to the member, and thereby a larger percentage apportioned to the third party beneficiary.

9. The method according to claim 8, wherein data indicative of the member or the third party beneficiary is associated with the member card.

10. The method according to claim 7, wherein the merchant has a pre-defined monetary benefit in respect of a purchase value, and pre-defined monetary benefit can be shared between at least the member and the third party beneficiary.

11. The method according to claim 7, wherein a percentage of the defined benefit is a rebate to a member purchase, and a remaining portion of the defined benefit contributes toward a transfer of funds to the third party beneficiary.

12. The method according to claim 11, wherein the remaining portion of a defined benefit is temporarily held in an intermediary account.

13. A shared benefit membership reward apparatus for allocating a portion of a purchase-based member reward to a third party beneficiary, the apparatus comprising:
a processor element adapted to interrogate a member card for identifying data indicative of a member and the third party beneficiary;
the processor element being further adapted to calculate a defined benefit in respect of a purchase value, apportion a percentage of the defined benefit to the member, and apportion a remaining portion of the defined benefit toward a transfer of funds to the third party beneficiary.

14. The apparatus according to claim 13, wherein:
the processor element is located at a merchant point of sale, and is couplable to a data network,
the processor element being further adapted to transmit data across the data network to a payment processing provider for enabling the transfer of funds from a merchant account to a third party beneficiary account.

15. The apparatus according to claim 14, wherein enabling the transfer of funds from the merchant account to the third party beneficiary account initially requires transferring funds to an intermediary account.

16. The apparatus according to claim 13, wherein the merchant has a pre-defined monetary benefit in respect of a purchase value, and the processor element being further adapted to share the pre-defined monetary benefit between at least the member and the third party beneficiary.

17. The apparatus according to claim 16, wherein a percentage of the defined benefit is a rebate to a member purchase, and a remaining portion of the defined benefit contributes toward a transfer of funds to the third party beneficiary.

18. The apparatus according to claim 17, wherein fees and charges are extracted from the remaining portion of the defined benefit.

19. A computer-readable carrier medium carrying a set of instructions that when executed by one or more processors cause the one or more processors to carry out a method of allocating a portion of a purchase-based member reward to a third party beneficiary, thereby to enable a shared benefit membership reward in a computer system, the method comprising the steps of:
a) receiving a member card at a merchant point of sale;
b) identifying data indicative of a member;
c) identifying a third party beneficiary associated with the member card;
d) calculating a defined benefit in respect of a purchase value; and
e) apportioning a percentage of the defined benefit to the member and apportioning a remaining portion of the defined benefit being contributed toward the third party beneficiary.

20. The carrier medium according to claim 19, wherein the merchant has a pre-defined monetary benefit in respect of a purchase value, and the method further comprises the step of sharing the pre-defined monetary benefit between at least the member and the third party beneficiary.
